(19) United States
(12) Patent Application Publication
(10) Pub. No.: US 2008/0093885 A1
(43) Pub. Date: Apr. 24, 2008

(54) PLASTIC WINDOW ASSEMBLY FOR MOTOR VEHICLES

(76) Inventors: Sachiko Kurokawa, Novi, MI (US); Derek English, Detroit, MI (US); Srinivas Bidare, Novi, MI (US); Jason Cuellar, Southfield, MI (US); Alex Scholten, Langenfeld (DE)

Correspondence Address: EXATEC;C/O BRINKS HOFER GILSON & LIONE, P. O. BOX 10395, CHICAGO, IL, 60610, US

(21) Appl. No.: 11/876,080

(22) Filed: Oct. 22, 2007

Related U.S. Application Data
(60) Provisional application No. 60/862,281, filed on Oct. 20, 2006.

(51) Int. Cl. B60J 1/17

(52) U.S. Cl. 296/146.16

(57) ABSTRACT

A plastic window assembly for use in a motor vehicle has a plastic panel and a motor. The motor is coupled to a gear and is operable to drive the gear to move the plastic panel in a first panel direction and in a second panel direction. In one variation, the plastic panel has portions forming at least one gear track to define a gear path. In another variation, the window assembly has a frame, and the frame has portions defining a track. The track has a central section and a terminal section, the central and terminal sections intersecting and being non-collinear. In another variation, the plastic window assembly has a flexible strip. A first end of the flexible strip is connected to the gear and a second end of the flexible strip is connected to the plastic panel.

### CROSS-REFERENCE TO RELATED APPLICATIONS

This application claims the benefit of U.S. Provisional Application Ser. No. 60/862,281 filed on Oct. 20, 2006, entitled “POLYCARBONATE GLAZING FOR MODULAR DOORS,” the entire contents of which are incorporated herein by reference.

### BACKGROUND

1. Field of the Invention

The present invention generally relates to window assemblies for motor vehicles, and more particularly, to plastic window assemblies for motor vehicles.

2. Description of the Related Technology

Over the past several decades, automobile manufacturers have sought to improve automobiles in every way. From improving safety, to enhancing functionality, to lowering costs, they have made great strides. One area of great concern, especially recently, is the rising cost of gasoline. In the past few years alone, gasoline has reached record high prices in the United States. One way the industry is trying to combat the problem is by developing alternative fuel technologies. However, developing alternative fuel technologies involves barriers to entry, such as lack of infrastructure and available fuel sources. Another way the industry is addressing the problem of high gas prices is by attempting to introduce gasoline powered automobiles that are more fuel efficient. This has been accomplished to some extent by introducing more efficient drive trains, but there are limitations to this approach. Other attempts have been made to reduce vehicle weight. However, in the past, it was generally believed that reducing the weight of a vehicle compromised the safety of the vehicle.

Windows in automobiles have typically been constructed of glass. Automotive glass has many limitations due to the constraints inherent with the material. More specifically, automotive glass is constrained by the need to include complex attachment and regulating systems. These systems add considerable weight to a door module, which is in addition to the weight of the glass itself. The additional weight of glass window assemblies impacts the performance of a car or truck by increasing fuel consumption and/or raising the center of gravity of the vehicle. Glass windows may also be undesirable because of their propensity to shatter, and because they may need to be shattered in an emergency situation to create an escape route.

### SUMMARY

The present invention provides a plastic window assembly for a motor vehicle that adds less complexity and less extra weight to a motor vehicle, as compared to a glass window assembly. Further, the present invention improves the safety of a motor vehicle, even though the present invention causes a motor vehicle to weigh less than a similar motor vehicle having a glass window assembly.

The plastic window assembly generally includes a plastic window panel and motor. The motor is coupled to a gear that operates to move the plastic window panel between opened and closed positions.

In one aspect, the plastic window panel of the plastic window assembly has at least one gear track to define a gear path.

In another aspect, the plastic window assembly includes a frame having portions forming a pair of intersecting, non-planar tracks.

In yet another aspect, the plastic window assembly includes a flexible strip, having a first end and a second end, one end of which is connected to the gear and another end of which is connected to the plastic window panel.

These and other aspects and advantages of the present invention will become apparent upon reading the following detailed description of the invention in combination with the accompanying drawings.

### BRIEF DESCRIPTION OF THE DRAWINGS

FIG. 1 is a perspective view of a plastic window assembly embodying the principles of the present invention;

FIG. 2 is a front view of the window assembly seen in FIG. 1;

FIG. 3 is a partial, side view of the window assembly of FIG. 1;

FIG. 4 is a front view of another embodiment of a plastic window assembly according to the principles of the present invention;

FIG. 5 is a partial side view of the window assembly of FIG. 4;

FIG. 6 is a schematic exploded cross-sectional view of the window assembly seen in FIGS. 4 and 5;

FIG. 7A is a schematic side cross-sectional view of the window assembly of FIG. 4 in a closed position;

FIG. 7B is a cross-sectional view generally taken along the line 7-7 in FIG. 7A;

FIG. 8A is a perspective view of the window assembly of FIG. 4 in a partially open position;

FIG. 8B is a schematic side cross-sectional view of the window assembly of FIG. 4 in a partially open position;

FIG. 8C is a plan cross-sectional view of the window assembly of FIG. 4 in a partially open position;

FIG. 9 is a schematic side cross-sectional view of the window assembly of FIG. 4 in a completely open position; and

FIG. 10 is a perspective view of yet another plastic window assembly embodying the principles of the present invention.

### DETAILED DESCRIPTION

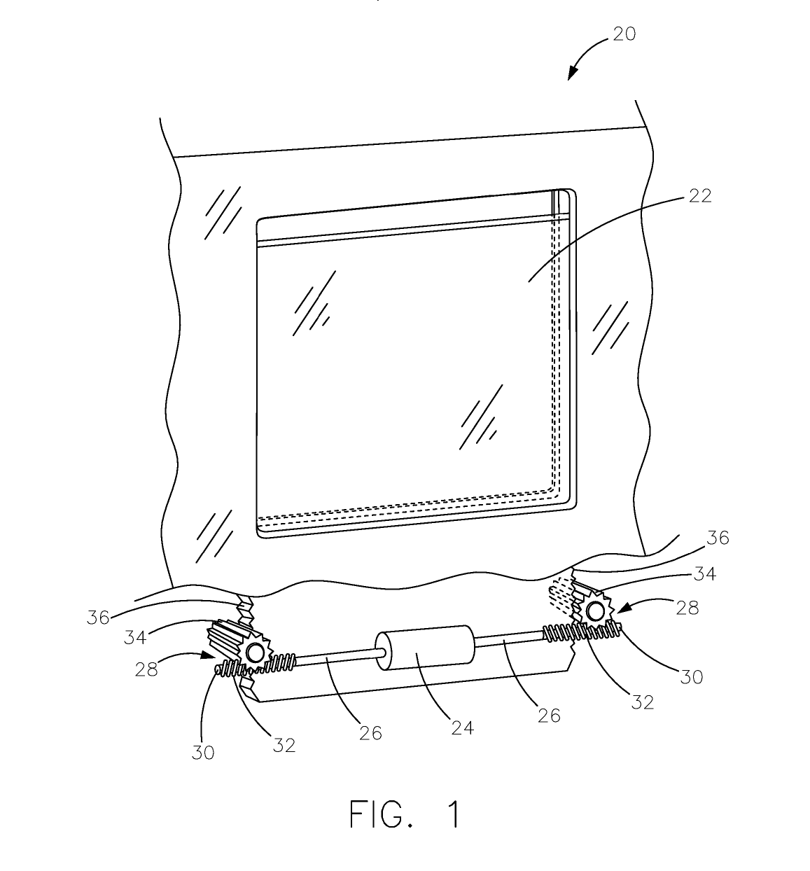

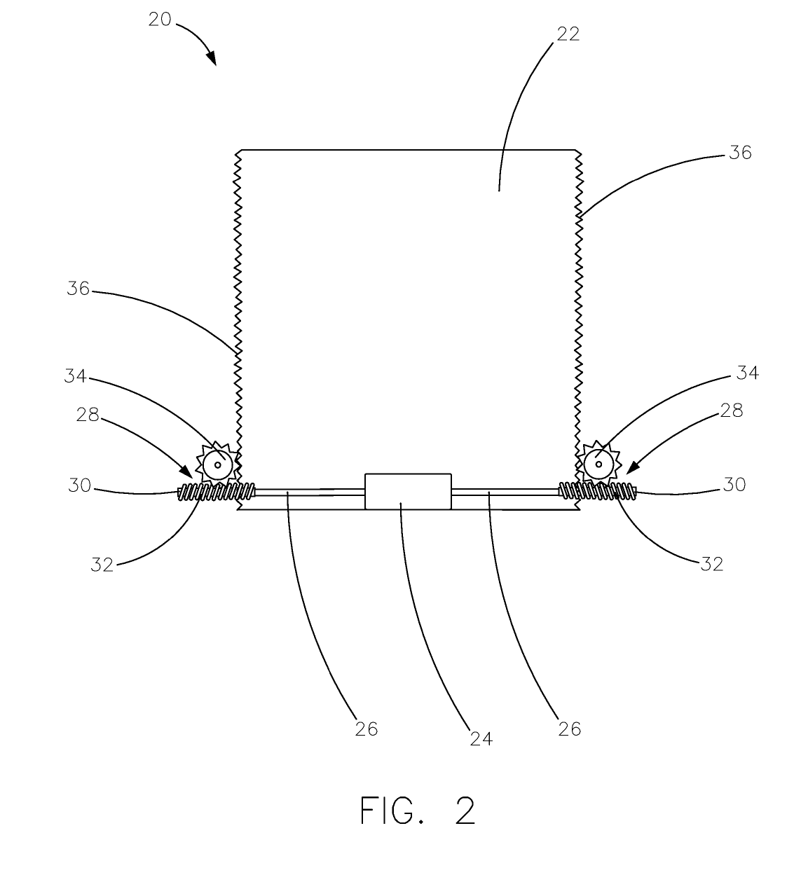

Referring now to FIGS. 1-3, a plastic window assembly for use in a motor vehicle is illustrated therein and generally designated at 20. The plastic window assembly 20 includes a plastic panel 22, a motor 24, an output shaft 26 extending from each side of the motor 24, and worm gear trains 28 located at the distal ends 30 of the shafts 26.

Each worm gear train 28 comprises a worm 32 in meshing engagement with a worm wheel 34. The worms 32 are mounted to the shafts 26 so as to be rotationally driven thereby. The shafts 26 may be a single shaft extending through the motor 24 or it may be two shafts 26, with one shaft 26 extending from each side of the motor 24. Each worm wheel 34 preferably has supporting structure (not shown) to prevent translational movement of each worm wheel 34.

Preferably, the plastic panel 22 is made of polycarbonate, which has a high impact strength and excellent transparency. However, other suitable materials may include, by way of example, polymethylmethacrylate (PMMA), acrylic, polyacrylate, polyester, polysulfone, or copolymers, and combinations thereof. It is also contemplated that the plastic panel 22 could be formed of other thermoplastic resins, or any other suitable material. The plastic panel 22 may include bisphenol-A polycarbonate and other polycarbonate resin grades (such as branched or substituted) as well as being copolymerized or blended with other polymers, thereby, forming a blend with Acrylonitrile Butadiene Styrene (PC/ABS blend), or a polyester (PC/POLYESTER blend). The plastic panel 22 is most preferably transparent, and less preferably translucent. The plastic panel 22 may further comprise various additives, such as colorants, mold release agents, antioxidants, and ultraviolet absorbers.

The plastic panel 22 may also include various protective or functional layers located on the surface of the plastic panel 22. The protective or functional layers may include one or more of a weathering layer, a conductive layer, a decorative layer, and an abrasion resistant layer. Theses layers may be provided on either or both sides of the plastic panel 22, and more than one of the same type of layer can be included on the same side of the plastic panel 22. For example, there could be multiple weathering layers for enhanced protection from the sun and other elements. By way of example, the weathering layer may include a film comprising polycarbonate, PMMA, a combination of polycarbonate and PMMA, polysiloxane, polyurethane, polyurethane acrylate, or any other suitable material. Further, the weathering layer may include a coating of a material such as acrylic, polyurethane, siloxane, or a combination of these types of materials to provide a high weatherability, including long term ultraviolet (UV) protection. Further, silicone nano-particles may be blended into the weathering layer or a siloxane co-polymer may be formed into the material making up the weathering layer by polymerization, which may help promote adhesion between the weathering layer and adjacent layers. The weathering layer may also include UV absorbing molecules, such as, by way of example, one or more of or a combination of inorganic oxides, benzophenones, benzoylresorcinols, cyanoacrylates, triazines, oxanilides, and benzotriazoles. Preferably, the weathering layer has a thickness between 10 and 1250 micrometers. The weathering layer may be as described in U.S. Pat. No. 6,797,384, which is hereby incorporated by reference in its entirety.

The conductive layer could be provided as a resistive layer or grid, to serve as a heater, defroster, defogger, or an antenna, by way of example. The conductive layer may be formed of a printed resistive ink or a transparent conductive layer, for example, applied to the plastic panel 22 or one of the other layers.

The decorative layer could add any desired decoration to the plastic panel 22. For example, the decorative layer could be a decorative printed ink or a blackened border to conceal fit and finish imperfections.

The abrasion resistant layer may include a single layer or multiple sub-layers. The abrasion resistant layer may be comprised of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or a mixture or blend thereof. Preferably, the abrasion resistant layer is comprised of a composition of SiOₓ or SiOₓC_{y}H_{z} depending upon the amount of carbon and hydrogen atoms that remain in the deposited layer. In this regard, the abrasion resistant layer resembles a “glass-like” coating. The abrasion resistant layer may also comprise UV absorbing molecules, such as, but not limited to, inorganic oxides, benzophenones, benzoylresorcinols, cyanoacrylates, triazines, oxanilides, and benzotriazoles.

The various layers may be applied by any technique known to those skilled in the art. Such techniques include, by way of illustration and not limitation, coating techniques (sol gel, spray, flow, dip, and curtain), film insert molding techniques, printing techniques (screen printing, membrane image transfer, pad printing), and deposition techniques (plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition).

The plastic panel 22 has gear tracks 36 located on the two opposing side edges of the plastic panel 22 to define the gear path for each worm wheel 34. The gear tracks 36 are preferably formed directly in the plastic panel 22, for example, by being molded into the plastic panel 22. In the alternative, the gear tracks 36 could be formed separately from the plastic panel 22 and attached to the plastic panel 22. In the latter case, the gear tracks 36 could be formed of a material other than plastic, such as metal. In either construction, the gear tracks 36 form gear teeth that mesh with the worm wheels 34.

The motor 24 is operable to alternatively rotate the shafts 26 in opposing rotational directions. Because the worms 32 are fixed to the shafts 26, they rotate when the shafts 26 rotate. Rotation of the worms 32 causes the worm wheels 34, which are meshed therewith, to also rotate. The worm wheels 34 are further meshed with the gear tracks 36 such that rotation of the worm wheels 34 causes the plastic panel to be displaced in a translational direction. In the present embodiment, the worm wheels 34 and the grooved tracks 36 form rack and pinion gear sets, wherein the rotational motion of the worm wheels 34 is converted to linear motion of the plastic panel 22. Since the motor 24 is capable of rotating the shafts 26 and worms 32 in opposite rotational directions, the worm wheels 34 also are capable of moving in opposite rotational directions. Thus, the worm wheels 34 may move the plastic panel 22 in a first linear direction and a second linear direction. For example, if the plastic panel 22 is installed as a side window in an automobile, the plastic panel 22 will be moved in upward and downward directions, and if the plastic panel 22 is installed as a sun roof, the plastic panel 22 will be moved in forward and rearward directions.

Although the plastic panel 22 is illustrated having gear tracks 36 on two opposite sides of the plastic panel 22, it should be understood that a gear track 36 could be located on merely one side of the plastic panel 22, with one corresponding worm gear train 28. In another embodiment, a single gear track 36 could be provided on a central portion or extension of the plastic panel 22. In such an embodiment, the plastic panel 22 would preferably have extra length to accommodate the length of the gear track 36 without exposing any of the gear track 36 in a visible portion of the plastic panel 22 when the plastic panel 22 is in the closed position.

In another embodiment, the gear tracks 36 could be formed into a shape other than the simple gear teeth as shown. For example, the worm wheels 34 could be thin disc-shaped gears, which would allow the gear tracks 36 to take on other configurations or constructions, such as a plurality of indented squares or the like. Likewise, if the gear tracks 36 were provided on a front surface, as opposed to a side surface, of the plastic panel 22, then still other embodiments of the gear tracks 36 are possible, without falling beyond the spirit and scope of the present invention.

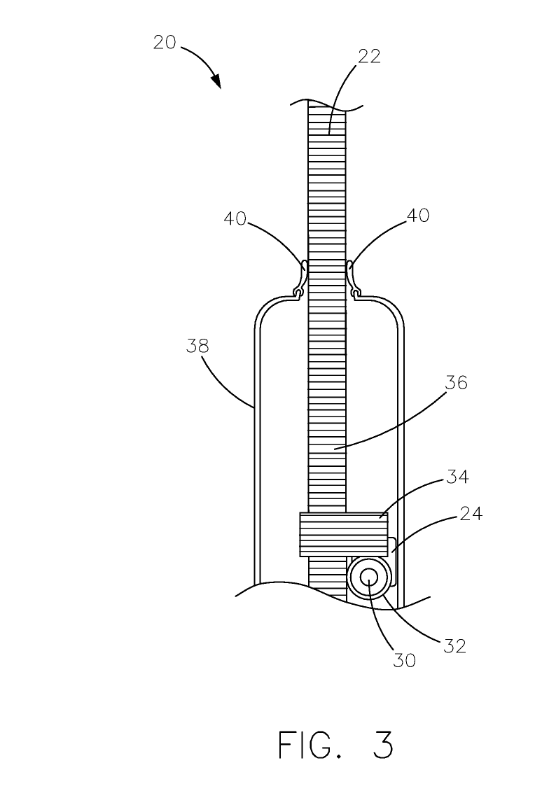

As shown in FIG. 3, the window assembly 20 is installed in a door 38 of a motor vehicle. As such, the door 38 includes weather strips 40 contacting each surface of the plastic panel 22 to keep outside elements and particles out of the door 38.

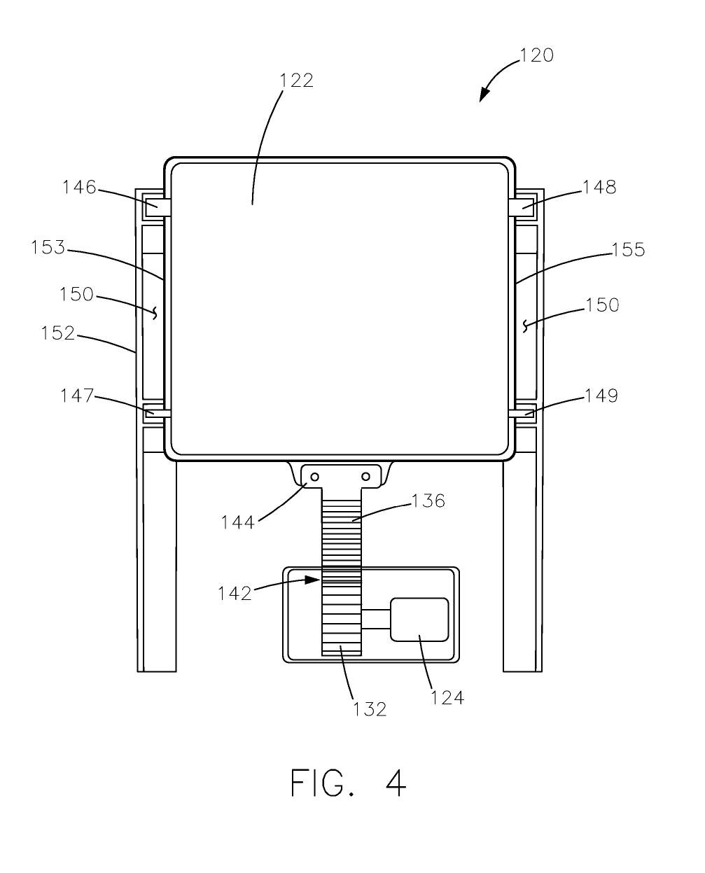

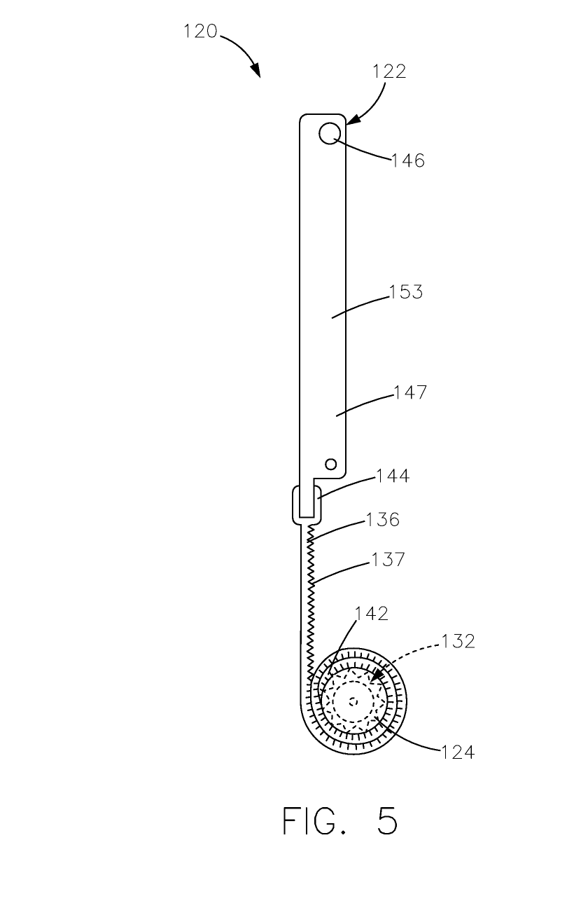

Now with reference to FIGS. 4-9, another embodiment of a plastic window assembly 120 according to the principles of the present invention is illustrated therein. As with the prior embodiment, the assembly 120 includes a plastic window panel 122 and a motor 124, wherein the motor 124 is coupled to a gear 132. The gear 132 is connected to a flexible strip 136 having a first end 142 and a second end 144, and which is preferably formed of a plastic material, an elastomeric material, or a combination thereof. The first end 142 of the flexible strip 136 is connected to the gear 132 and the second end 144 of the flexible strip 136 is connected to the plastic panel 122. The flexible strip 136 has a plurality of grooves 137 that enable the plastic strip 136 to roll up around the gear 132, which will be described in further detail below. The plastic panel 122 may be comprised of polycarbonate or any of the other materials previously mentioned with reference to FIGS. 1-3 and the plastic panel 22. Likewise, the plastic panel 122 may have protective or functional layers located thereon, as hereinbefore described.

The motor 124 is operable to drive the gear 132 so as to move the plastic panel 122 between an extended and a retracted position. More specifically, the motor 124 is operable to rotate the gear 132 in opposing rotational directions. When the gear 132 is rotated in a first rotational direction, the flexible strip 136 is wound, or rolled up, around the gear 132 and pulls or moves the panel 122 to its retracted position. When the gear 132 is rotated in the opposing rotational direction, the flexible strip 136 is unwound from the gear 132 and the plastic panel 122 is pushed in a second direction (opposite to the first direction) which moves the plastic panel 122 to its extended position.

Extending from the lateral side edges of the plastic panel 122 are a plurality of projections or guide pins. As shown, two guide pins 146, 147 extend from a first side 153 of the plastic panel 122, and two additional guide pins 148, 149 extend from the opposite side 155 of the plastic panel 122. The pins 146, 147, 148, 149 are received within and guide the plastic panel 122 along tracks 150 of a window frame 152, which is described in further detail below. The pins 146, 147, 148, 149 are preferably formed of polycarbonate and unitarily formed with the plastic panel 122. In the alternative, the pins 146, 147, 148, 149 may be formed separately from the plastic panel 122 and/or they may be formed of a different material from the plastic panel 122. For example, the pins 146, 147, 148, 149 may be formed of metal if desired, or they may be formed of black plastic with a black frame of the plastic panel 122 and attached to the plastic panel 122.

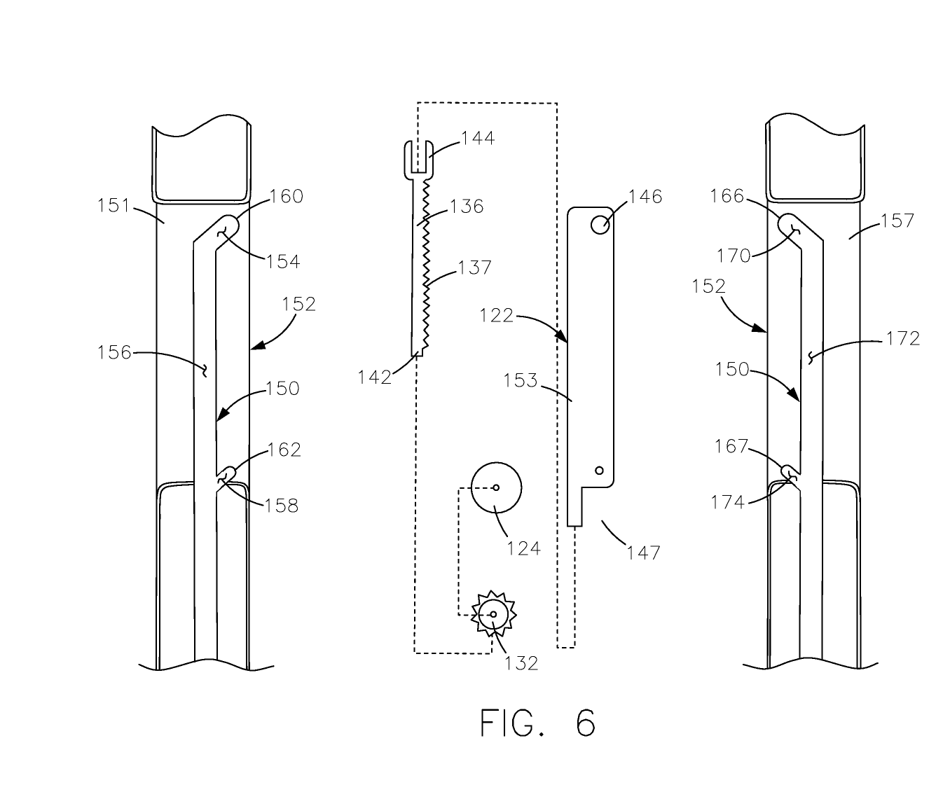

With reference to FIG. 6, a schematic exploded cross-sectional view of the window assembly 120 is shown, and the tracks 150 of the frame 152 are more clearly seen. As shown, the frame 152 includes a pair of opposing side portions 151, 157, within which the tracks 150 are formed as mirror images of one another. The tracks 150 themselves each include a central section 156, 172, a terminal section 154, 170 and an intermediate section 158, 174 with respective terminal and intermediate sections 154, 170, 158, 174 extending from a common side at a common oblique angle from the central sections 156, 172. Thus, terminal and intermediate sections 154, 170, 158, 174 are all generally parallel to one another. As denoted by the nomenclature used to describe them, the terminal sections 154, 170 are provided at the terminal ends of the central sections 156, 172. This position also locates the terminal sections 154, 170 toward one end of the window opening in the vehicle. The intermediate sections 158, 174 are accordingly located at an intermediate portion of the central portion 156, 172. This position is chosen so as to locate the intermediate portions 158, 174 toward an opposing side of the window opening.

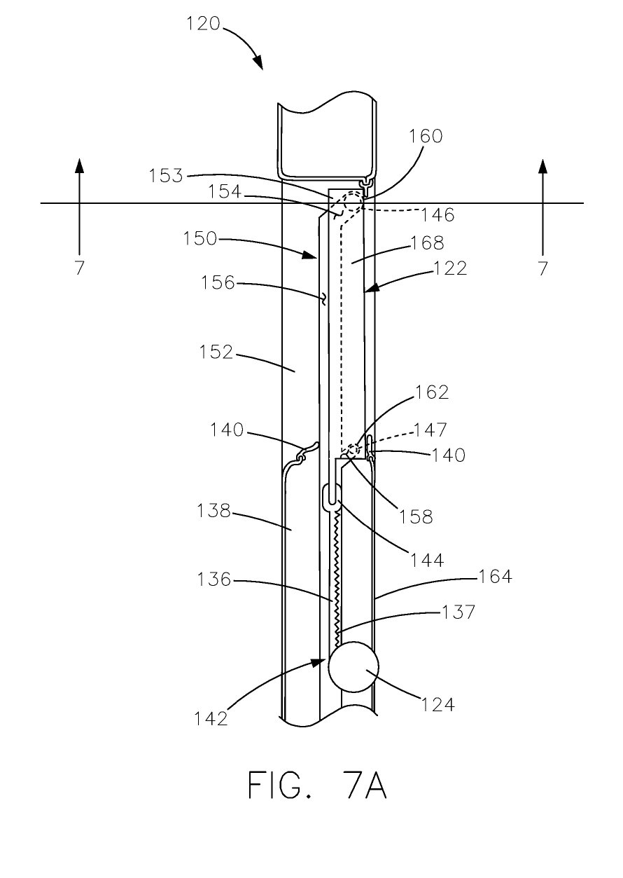

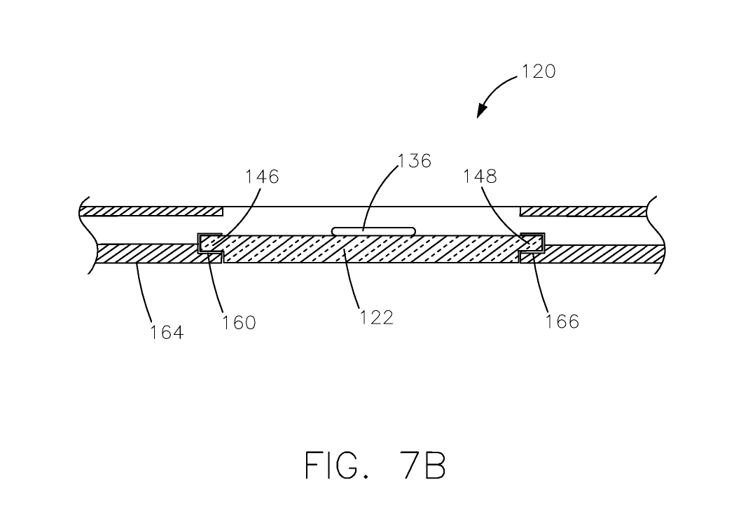

With reference to FIG. 7A, a schematic side view of the window assembly 120 is illustrated. FIG. 7A shows the window assembly 120 in a vehicle door in a closed position. In other words, the plastic panel 122 is in its extended, closed or uppermost position. Since the figure is representative of a vehicle door, orientational references to up/down, and similar terminology, are with reference to the normal orientation of a vehicle. Also, while the window assembly 120 is shown in use in a door 138 of a motor vehicle, it will be understood that the window assembly 120 could alternatively be used as a sun roof, or as a window that is not located in a door 138.

As seen in FIG. 7A, when the plastic panel 122 is in the uppermost position, the leading guide pins 146, 148 are located in the distal ends 160, 166 of the terminal sections 154, 170 of the tracks 150. Similarly, the trailing guide pins 147, 149 are located in the distal ends 162, 167 of the intermediate sections 158, 174. As previously noted, the trailing guide pins 147, 149 and intermediate sections 158, 174 may be omitted in some designs. In this uppermost or closed position, the plastic panel 122 is flush or nearly flush with the exterior surface 164 of the motor vehicle (see FIG. 7B). While not shown, the plastic panel 122 may include a rubber seal on each side 153, 155 of the plastic panel 122 to account for thermal expansion, reduce noise, and provide weather protection. As previously mentioned, weather strips 140 may be provided to keep elements and debris out of the door 138.

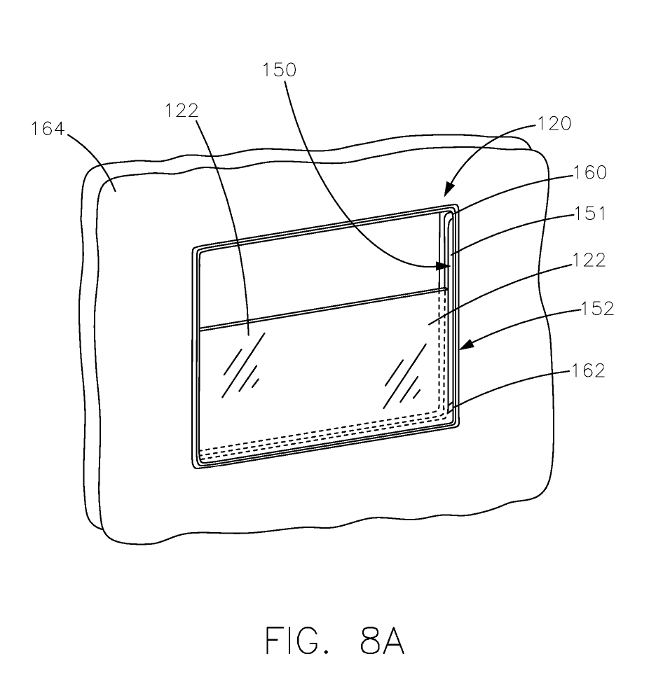

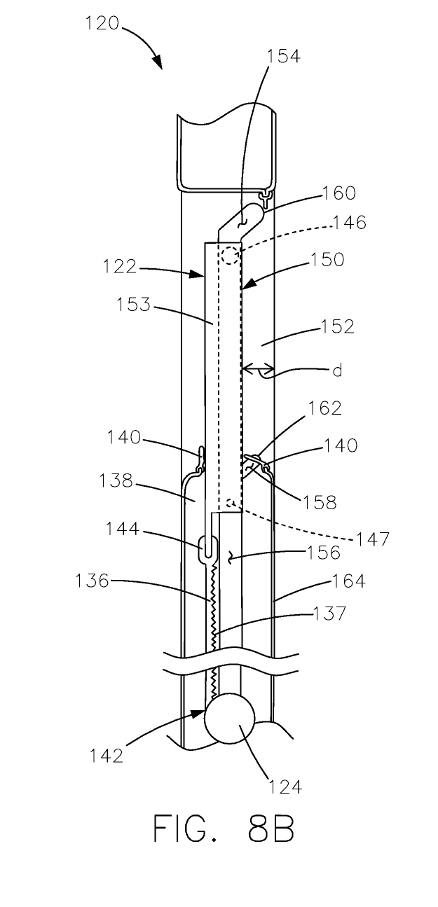

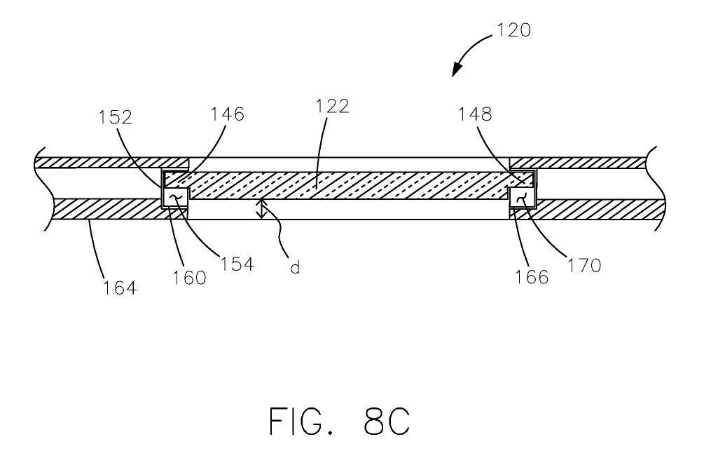

Now with reference to FIGS. 8A-8C, window assembly 120 is shown in a partially retracted, open, or down position. In the partially down position, the leading guide pins 146, 148 have slid from the terminal sections 154, 170 to the central sections 156, 172 and, similarly, the trailing guide pins 147, 149 have slid from the intermediate sections 158, 174 to the central sections 156, 172 of the tracks 150. When the guide pins 146, 147, 148, 149 are in the central sections 156, 172 of the tracks 150, the exterior surface of the plastic panel 122 is located a distance d from the exterior surface 164 of the motor vehicle and is no longer flush therewith.

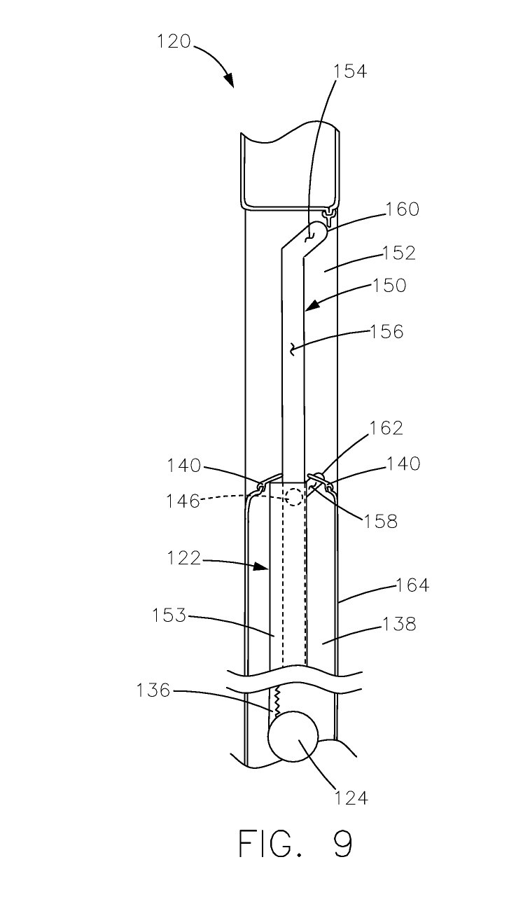

With reference to FIG. 9, the plastic panel 122 is shown in a retracted, open, or down position, wherein the plastic panel 122 has been moved completely into the door 138 of the motor vehicle. As described above, the motor 124 is operable to reverse its rotational direction and push the plastic strip 136 and plastic panel 122 back upward. When the plastic panel 122 nears the top of the frame 152, the leading guide pins 146, 148 slide into the terminal sections 154, 170 (the trailing guide pins 147, 149 similarly cooperating with the intermediate sections 158, 174) to bring the plastic panel 122 flush with the exterior surface 164 of the motor vehicle. It should be noted that in embodiments having both leading and trailing guide pins, the leading guide pins 146, 148 are preferably larger than the trailing guide pins 147, 149 and the terminal sections 154, 170 are preferably wider than the intermediate sections 158, 174. The largeness of the leading guide pins 146, 148 in relation to the intermediate sections 158, 174 prevents these pins 146, 148 from sliding into those sections 158, 174 when the plastic panel 122 is moving upward. Thus, the window assembly 120 is prevented from becoming jammed.

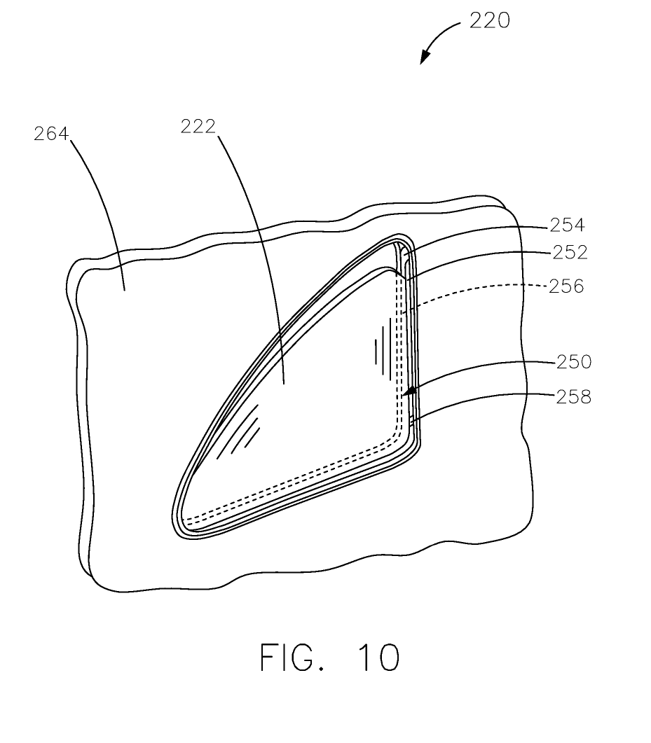

Now with reference to FIG. 10, another window assembly 220 is illustrated. The window assembly 220 is substantially similar to the window assembly 120 of FIGS. 4-9; however, the window assembly 220 has a plastic panel 222 that generally has the shape of a quarter of an oval. Even more generally, the plastic panel 222 is somewhat triangular in shape.

In this embodiment, the plastic panel 222 has guide pins (not shown) extending from only one side of the plastic panel 222. The frame 252 has a corresponding set of tracks 250, including a central section 256, a terminal section 254, and an intermediate section 258. The window assembly 220 operates similarly to the window assembly 120 of FIGS. 4-9, wherein the plastic panel 222 is flush with the exterior surface 264 of the motor vehicle when the pins are located at distal ends of the terminal and intermediate sections 254, 258. The plastic panel 222 is not flush with the exterior surface 264 when the guide pins are sliding within the central section 256.

Weight reduction, in addition to replacing glass with polycarbonate, is achieved by being able to utilize a lighter regulator system. Both worm gear trains 28 and direct motor drives 24, 124 are light weight, are compact in size, and can be directly coupled to the plastic window. The guide pins and other features may be molded directly into the plastic panel 22, 122, 222. Thus, the design of the present window assembly 20, 120, 220 reduces overall complexity of the window and door module.

As a person skilled in the art will readily appreciate, the above description is meant only as illustrative implementation of the principles this invention. This description is not intended to limit the scope or application of this invention in that the invention is susceptible to modification, variation and change, without departing from the spirit of this invention.

1. A plastic window assembly for use in a motor vehicle, the plastic window assembly comprising:
a plastic panel; and
a motor coupled to a gear, the motor being operable to drive the gear to move the plastic panel in a first panel direction and in a second panel direction.

2. The plastic window assembly of claim 1, wherein the plastic panel comprises portions forming at least one gear track to define a gear path.

3. The plastic window assembly of claim 2, wherein the at least one gear track is molded into the plastic panel.

4. The plastic window assembly of claim 2, wherein the at least one gear track comprises a first gear track located on a first side of the plastic panel and a second gear tracked located on a second side of the plastic panel.

5. The plastic window assembly of claim 4, further comprising at least one shaft coupled to the motor, the gear being a first worm located at a first end of the at least one shaft, the plastic window assembly further comprising a second worm located at a second end of the at least one shaft, the motor being operable to rotate the at least one shaft and the first and second worms.

6. The plastic window assembly of claim 5, further comprising a first worm wheel meshed with the first worm and the first gear track, the plastic window assembly further comprising a second worm wheel meshed with the second worm and the second gear track, wherein upon rotation of the at least one shaft and first and second worms, the first and second worm wheels are rotated to drive the plastic panel in at least one of the first and second panel directions.

7. The plastic window assembly of claim 4, wherein the plastic panel comprises polycarbonate.

8. The plastic window assembly of claim 1, further comprising a frame having portions defining a track, the track having a central section and a terminal section, the central and terminal sections intersecting and being non-collinear.

9. The plastic window assembly of claim 8, wherein the track further comprises an intermediate section, the intermediate section intersecting the central section, the intermediate section being parallel to the terminal section.

10. The plastic window assembly of claim 9, wherein the track is a first track, the frame further comprising portions defining a second track disposed opposite to and aligned with the first track, the second track having a central section, a terminal section, and an intermediate section, the plastic panel further comprising guide pins, each guide pin being received within one of the first and second tracks for guiding the plastic panel along the first and second tracks as the plastic panel is moved in the first and second panel directions, the guide pins extending from a side of the plastic panel and being slidable along the tracks.

11. The plastic window assembly of claim 10, wherein the plastic panel is about flush with an exterior surface of the motor vehicle when the guide pins are located in a distal end of the terminal sections of the tracks.

12. The plastic window assembly of claim 11, wherein the plastic panel is not flush with the exterior surface of the motor vehicle when the guide pins are located in the central sections of the tracks.

13. The plastic window assembly of claim 9, further comprising a flexible strip having a first end and a second end, the first end of the flexible strip being connected to the gear and the second end of the flexible strip being connected to the plastic panel.

14. The plastic window assembly of claim 13, wherein the motor is operable to rotate the gear in a first gear direction and in a second gear direction, wherein when the gear is rotated in the first gear direction, the flexible strip is wound around the gear and the plastic panel is moved in the first panel direction, and wherein when the gear is rotated in the second gear direction, the flexible strip is unwound from the gear and the plastic panel is moved in the second panel direction.

15. The plastic window assembly of claim 13, wherein the flexible strip comprises at least one of plastic and elastomeric material.

16. The plastic window assembly of claim 13, wherein the plastic panel comprises polycarbonate.

17. The plastic window assembly of claim 8, wherein the plastic panel comprises a pair of guide pins extending from opposing sides of the plastic panel, the plastic window assembly further comprising portions defining opposing tracks, the opposing tracks having terminal sections, central sections, and intermediate sections, the terminal and intermediate sections being parallel to one another and obliquely intersecting the central section.

18. The plastic window assembly of claim 1, further comprising a flexible strip having a first end and a second end, the first end of the flexible strip being connected to the gear and the second end of the flexible strip being connected to the plastic panel.

19. The plastic window assembly of claim 18, wherein the motor is operable to rotate the gear in a first gear direction and in a second gear direction, wherein when the gear is rotated in the first gear direction, the flexible strip is wound around the gear and the plastic panel is moved in the first panel direction, and wherein when the gear is rotated in the second gear direction, the flexible strip is unwound from the gear and the plastic panel is moved in the second panel direction.

20. The plastic window assembly of claim 18, wherein the flexible strip comprises at least one of plastic and elastomeric material.
